(19) United States
(12) Patent Application Publication
(10) Pub. No.: US 2010/0257281 A1
(43) Pub. Date: Oct. 7, 2010

(54) Peer Connections Over Alternative Communication Mechanisms

(75) Inventors: Parveen K. Patel, Redmond, WA (US); Jitendra D. Padhye, Redmond, WA (US); Ranveer Chandra, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/417,745

(22) Filed: Apr. 3, 2009

(51) Int. Cl. G06F 15/173

(52) U.S. Cl. 709/239

(57) ABSTRACT

Alternate communication paths may be analyzed and selected for ongoing communications between two devices. One or both of the communicating devices may identify available communication paths and various identifiers on those paths. The identifiers may be, for example, base stations for a wireless connection, beacon signals, or other information that may be received by the device. After comparing the available communication paths to identify one or more alternative paths, the ongoing communications may be transferred to the alternative path. The initial communication path may be used to pass authentication and encryption information that may be used to establish the alternative path between the devices. The redirection of a communication stream may be performed by an interceptor inserted between the application layer and transport layer in a network stack of the communicating devices.

### BACKGROUND

Many networking applications use a network infrastructure to communicate between two devices. The network infrastructure may involve a remote server or some other centralized connection through the Internet or other wide area network. Such an infrastructure may enable two devices to communicate when the devices are located anywhere around the globe.

The network infrastructure that enables communication from anywhere typically has some complexities and costs. For example, a remote server typically facilitates the connection and routes the communication. Even though the two devices at the end of the communication path may be in the same room, communications may be transmitted hundreds or even thousands of miles across long distance communication lines to reach the other device.

Such communication paths typically come with some performance costs. Long distance round trip communications typically have some latency and delay in communicating, and may have some bandwidth restrictions.

### SUMMARY

Alternate communication paths may be analyzed and selected for ongoing communications between two devices. One or both of the communicating devices may identify available communication paths and various identifiers on those paths. The identifiers may be, for example, base stations for a wireless connection, beacon signals, or other information that may be received by the device. After comparing the available communication paths to identify one or more alternative paths, the ongoing communications may be transferred to the alternative path. The initial communication path may be used to pass authentication and encryption information that may be used to establish the alternative path between the devices. The redirection of a communication stream may be performed by an interceptor inserted between the application layer and transport layer in a network stack of the communicating devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for communicating over a best network.

FIG. 2 is a flowchart illustration of an embodiment showing a method for managing communications by a communications management server.

FIG. 3 is a flowchart illustration of an embodiment showing a method for managing communications that may be performed by one device that is communicating with another device.

FIG. 4 is a diagram illustration of an embodiment showing a network stack topology.

### DETAILED DESCRIPTION

Communication streams between two devices may be changed from one port to another by a mechanism that intercepts the communications between an application layer and a transport layer of a network stack. The interceptor may redirect the communications through a different port after a communications manager identifies the alternative port.

A communications manager may gather metadata on alternative paths available to the devices and analyze the metadata to identify communication paths and select the best path for the given circumstances. Some embodiments may analyze the burstiness of a communication stream, the bandwidth or other performance capabilities of the alternative paths, as well as other factors in determining a best path. A monitoring system may continually or periodically monitor the communication steam as well as the communication mechanisms to determine if another path may be better suited to changing conditions.

Some embodiments may use a remote server to manage the communication paths. Other embodiments may be deployed on a peer to peer level, or where one of the communicating devices performs the communication manager functions.

Many embodiments may be deployed with a communication client on each device. The communication client may perform some of the data collection and other management functions, and may receive and process commands from a communications manager.

Throughout this specification, like reference numbers signify the same elements throughout the description of the figures.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

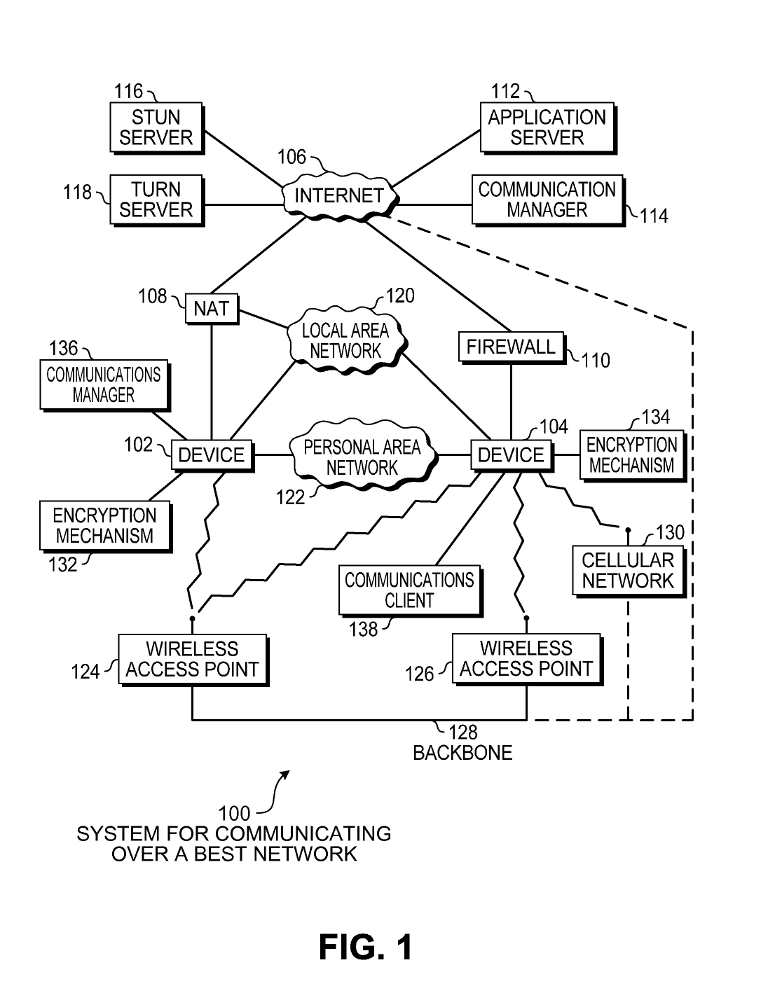

FIG. 1 is a diagram of an embodiment 100 showing a system that may manage communications across different communication paths. Embodiment 100 is a simplified example of an environment where such a management system may operate, and illustrates several different types of deployments and implementations.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a system for managing communications between device 102 and device 104. The devices 102 and 104 may be any type of device that communicates and has at least two different mechanisms or paths through which communication may occur. The system may identify alternative paths for communications, then select the best path for the current situation.

The devices 102 and 104 may collect identifiers for devices or networks available on any ports for the device, as well as other metadata. The metadata from the two devices may be compared to identify communication paths where both devices sense the same network or devices.

The sensing may be passive, where the devices listen to traffic, beacon signals, or other information that can be collected. The sensing may be active, where the devices perform queries of other devices or networks accessible on a communication path. The sensing may be assisted in some cases, where one or both devices may broadcast on a communication path while the other device listens for the transmitted signal from the other device.

When a commonly accessible communication path is identified, a communication session may be created and an ongoing communication stream from an existing communication path may be redirected to the second communication path. In many cases, the second communication path may be an ad-hoc network.

The communication management system may determine the best communication path for the current situation. In some situations, a default communication path may be created using the Internet 106, for example. When devices are located within a local area network 120, or when the devices are in close enough proximity to use a personal area network 122, for example, a communication path may be opened using the local area network 120 or personal area network 122. In many cases, an ad-hoc network may be formed between two or more devices.

A monitoring system may evaluate the performance of the second communication path to determine if the second communication path continues to be the best communication path. The evaluation may be based on the status or performance of the communication path or whether the characteristics of the data being transmitted have changed.

Many of today's electronic devices have multiple communication mechanisms, including different hardwired and wireless communication paths. Examples of hardwired communication paths include Ethernet, Universal Serial Bus (USB), or other hardwired analog or digital connections. In many cases, an Ethernet connection may be through a local area network to connect to the Internet.

Many devices also have one or more wireless connections, which may include long distance communications such as IEEE 802.16 (WiMax), Global System for Mobile Communications (GSM), EDGE, Personal Communication Service (PCS), W-CDMA (UMTS), and others. Many devices may have medium range wireless capabilities that may operate IEEE 802.11 (WiFi), Ultra Wide Band (UWB), and other standards. Short distance wireless connections may include infrared, such as IrDA, IEEE 802.15.4, Bluetooth, and other standards. In some cases, the short distance wireless connections may be labeled Personal Area Networks (PAN). Some embodiments may use other data communication techniques, such as ultrasonic or other communication medium.

In different situations, the various communication paths may be more optimal, depending on the proximity of the communicating devices and the type of data being communicated. Many different use scenarios for the communication management system exist.

One use scenario may be when devices 102 and 104 are a laptop computer and a cellular telephone. The laptop device may synchronize contacts, for example, or transfer other data with the cellular telephone. In a normal or default operation, the devices 102 and 104 may be connected through the Internet 106. However, both devices may be capable of communicating using other mechanisms or paths, such as infrared, short distance wireless, medium or long distance wireless, or some other mechanism. When initially connected, the laptop device and cellular telephone may connect via the Internet 106. The laptop device may have a hardwired connection through a Network Address Translation (NAT) device to the Internet 106. The cellular telephone device may connect through a cellular network 130 to the Internet 106.

When the devices are located near each other, such as next to each other on a desk or table, the communication between devices 102 and 104 may be changed to an ad-hoc network using one of the other communication paths to achieve higher response times or better data throughput than when the devices are connected through the Internet. In the scenario, the two devices may be located close enough to communicate using Bluetooth or some other personal area network and may communicate using a mechanism for which a user may not have to incur expense for connection time or data transfer.

Some embodiments may optimize the communication path based on economic factors. Some network connections may have a cost associated with length of time or bandwidth consumed. For example, some cellular telephones have a cost associated with each minute connected and some Internet connections may have a cost associated with the amount of data transmitted. When analyzing alternate communication paths, the cost of a connection may be used to select a communication path that minimizes costs.

Some devices may operate multiple virtual connections on a single hardware interface. Each of the virtual connections may be analyzed as separate connection paths when determining an optimal connection path. For example, a wireless hardware interface may be operated with several virtual wireless connections that may operate across the hardware interface. The virtual wireless connections may each connect to a different wireless device, for example.

In one such use scenario, two devices 102 and 104 may be connected to a wireless access point. Each device may establish a virtual connection over the hardware interface to the wireless access point as a default communication path. When a large amount of data is to be transmitted between the devices, a second virtual connection may be established over the same hardware interface, where the second virtual connection may be a direct connection between the two devices. In this case, the second virtual connection may be a second communication path.

In another use scenario, two devices 102 and 104 may be connected such that one device 102 is streaming media, such as audio or video, to the other device 104. The device 104 may have a player application that displays video or plays audio media, or may display an electronic book or other media. In a default communication mechanism, the devices 102 and 104 may connect over the Internet 108. This may enable the devices to communicate regardless of location, but may subject the communication to limited bandwidth and potentially poor transmission for a streaming media application. The communication management system may be able to identify a higher speed or more responsive second communication path such as a medium distance wireless communication path. By changing the communication path, a better performance of the streaming media may be achieved.

In some cases, a secondary communication path may be selected to minimize energy consumption on one or more of the devices. For example, a battery operated device may use less power when transmitting on a short distance communication path than when communicating over a long distance wireless connection, such as WiMax or a cellular network.

In still another use scenario, two devices may be connected to a synchronization application that synchronizes data among several devices. The synchronization application may be managed by a remote application server 112 that is accessed over the Internet 106. One such application may synchronize three, four, or more devices such that changes to data on any one of the devices may be propagated to the other devices. Such an application may be used for managing data on a large number of a company's handheld or mobile devices, laptops, or other devices, for example. Such an application may also be used by an individual user to manage personal folders of data files that may be used on a person's laptop, home computer, work computer, personal digital assistant, and personal mobile phone.

In such a scenario, the synchronization manager may operate in conjunction with a communications manager 114 to identify situations where two or more of the devices are capable of communicating directly with each other using alternative communication paths. In many cases, an alternate communication path may be an ad-hoc network. In other cases, a conventional network may be used. Such embodiments may be capable of connecting three or more devices on an ad-hoc network or alternate communications path.

In order to identify potential communication paths, the devices 102 and 104 may perform a discovery routine by searching all available paths to find identifiers for devices connected or connectable to the path. The identifiers may be any type of identifier for any type of device available over the path.

In some cases, the identifier may identify one or more networks that may available on a specific port. For example, a wireless communication port may sense one, two, or more different wireless networks available on the port, and may receive Service Set Identifier (SSID), or any other identifier that may be identify the available network. In another example, an Ethernet connection may identify a local area network 120 by receiving a domain name for a local area network, a default gateway, DHCP server address, or some other identifier that may be used to identify a network.

In other cases, the identifier may be a unique identifier for a device available over the communication path, such as a Media Access Control (MAC) address, an Internet Protocol (IP) address, a Fully Qualified Domain Name (FQDM), or other unique identifier.

Each device may broadcast or transmit a unique identifier during the discovery routine. The identifier that may be a network address for the device, a Globally Unique Identifier (GUID), or some other identifier. If the identifier is received by one of the devices, the communication path through which the identifier was received may be evaluated as a potential alternate communication path.

When devices are located within local area networks, the devices may be behind different firewall devices or gateways. For example, device 102 is illustrated as being behind a NAT device 108 and device 104 is illustrated as being behind a firewall device 110. In order for the device 102 to determine its full network address, the device 102 may query a Simple Traversal of User Datagram Protocol through Network Address Translators (STUN) server 116. The STUN server 116 may process a request from the device 102 and return the IP address and port. The IP address and port are used to connect to the device 102 from the Internet.

Similarly, device 104 may determine its full network address, the device 104 may query a Traversal Using Relay NAT (TURN) server 118. The TURN server 118 may process a request from the device 104 and return the IP address and port. The IP address and port are used to connect to the device 104 from the Internet. Other embodiments may use different mechanisms to determine a unique device address.

The IP address and port number or other identifier such as a GUID may be broadcast by one device when the other device is listening on a communication path during the discovery routine. In an example, the device 102 may determine its IP address and port number through a query to the STUN server 116. The IP address and port number may be broadcast through connections to a local area network 120, a personal area network 122, and various wireless connections. While the device 102 is broadcasting the IP address and port number, the device 104 may scan various paths to detect which devices are available through the path. When the IP address and port number of device 102 are received through one of the other paths, that path may be evaluated as a possible communication path between devices 102 and 104.

The management of communication paths may be performed by a communication manager 114, which may be a remote server or other device. In some cases, the communication paths may be managed by a communication manager 136 that may operate on one or both of the devices 102 and 104.

When a remote communications manager 114 is used, the devices 102 and 104 may or may not be in communication using a first communication path. The remote communications manager 114 may install communications clients on the devices 102 and 104, such as the communications client 138 on device 104. The communications clients may perform various functions such as broadcasting identifiers, performing discovery on various ports, and monitoring the ongoing communications.

In some cases, the communications manager 114 may collect addresses from each of the devices 102 and 104 and transmit the addresses to the other device so that the devices may identify each other during a discovery operation.

In other cases, the communications manager 114 may instruct the communication clients to perform a discovery operation without having the devices broadcast each other's address. In such cases, the devices may or may not broadcast a GUID or other identifier, and the discovery operations for each device may be performed independently.

An application server 112 may facilitate communications between the devices 102 and 104. For example, the application server 112 may coordinate synchronization of files between devices 102 and 104. In such an application, the devices 102 and 104 may separately communicate with the application server 112, then the application server 112 may facilitate a communication session between devices 102 and 104. Once the session is established, a communications manager 114 may be used to analyze alternative communication paths to see if any alternative path is available, select one of the paths as the best path, and cause the devices 102 and 104 to establish a second session using the best path.

In some embodiments, the communications manager 114 may perform the functions of identifying the devices 102 and 104 as having communications and may deploy communications clients to the devices 102 and 104. Once deployed, the communication clients may perform the functions of initiating a discovery routine, analyzing the results to determine a best path, and redirecting communications over the best path. In such a case, one or more of the devices may have a communications manager 136.

In many embodiments, the devices 102 and 104 may maintain two communication paths. An original or default communication path may be maintained as a back channel for signaling and control or may be a fall back channel if the other communication path is disconnected. Such an embodiment may be useful when the best communication path is a short distance wireless communication path that may be interrupted when the two devices are moved away from each other.

For example, two devices may have a communication path established through the Internet. After performing discovery, a Bluetooth connection is established as a best connection. The Bluetooth communication path may be used for transferring a bulk of the data between the devices. However, the Internet connection may be maintained and used for monitoring the performance of the Bluetooth connection as well as general signaling between the two devices. If the Bluetooth connection is interrupted, the data communication that was intended for the Bluetooth connection may be redirected through the Internet connection.

The devices 102 and 104 may search for various wireless communications as alternative communication paths. The wireless communications may take on several different forms, including ad-hoc networks, communications using a single wireless access point, and communications over a wireless network.

In an ad-hoc network, one of the devices may establish and manage the wireless communications between the two devices. In many embodiments of an ad-hoc network, one device may create an SSID and may manage the network communication between the two devices. Some such embodiments may transmit the SSID from the controlling device to the other device using the first communication channel, so that the second device may locate and connect using the SSID.

In some cases, two devices 102 and 104 may detect the same wireless access point 124. In some cases, the devices 102 and 104 may be able to communicate through the wireless access point 124, where the wireless access point 124 may serve as a router to forward communications from one device to the other. Such a communication path may have greater range and capabilities than an ad-hoc network. In some cases, the wireless access point 124 may be connected to the Internet 106. In some embodiments, the wireless connection may be one of several ways in which one of the devices may be connected to the Internet 106.

When both devices 102 and 104 detect a single wireless access point 124, the devices 102 and 104 may attempt a communication path through an ad-hoc network. In some embodiments, the devices 102 and 104 may be able to establish an ad-hoc network, and if the ad-hoc is unsuccessful, the devices 102 and 104 may attempt to establish a communication path where the wireless access point 124 relays the communication from one device to the other, without having to transmit the communications along the backbone 128.

The devices may create a second communication path using a wireless network that may consist of wireless access points 124 and 126 that are connected by a backbone 128. In such a case, the wireless network may have an SSID that is broadcast by both wireless access points 124 and 126 and detected by devices 102 and 104. In some cases, the wireless network may be connected to the Internet 106.

In some embodiments, the initial communication between the devices 102 and 104 may be secured by authentication and encryption. In such embodiments, the communication across the initial communication path may be secured. Using the initial communication path, a GUID or other identifier may be passed between the devices 102 and 104, and the GUID or other identifier may be used to authenticate a second communication path between the devices. In some embodiments, an encryption key may be passed between the two devices using the first communication path, and the encryption key may be used to encrypt communications along the second communication path. By using a GUID created by one device and communicated through a secure initial communication channel, and by using an encryption mechanism with keys passed through the secure initial communication channel, a second communication channel may be established that is at least as secure as the initial communication channel.

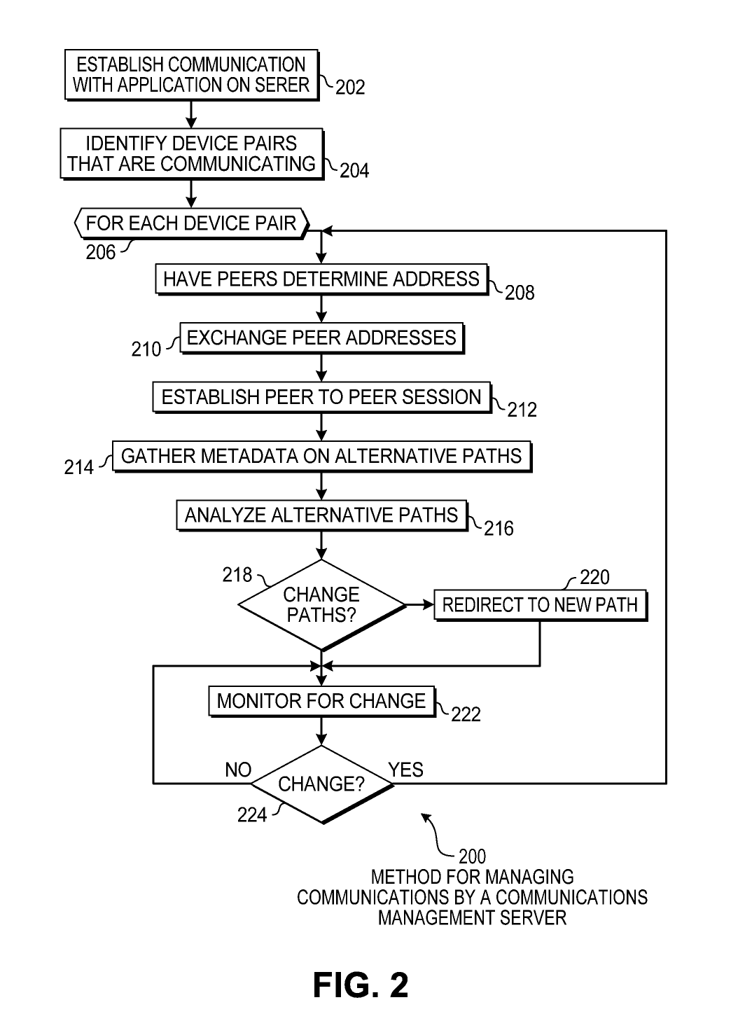

FIG. 2 is a flowchart illustration of an embodiment 200 showing a method for managing communications by a communication management server. Embodiment 200 is a simplified example of merely one method by which communications may be managed by a communication management server, such as the communication management server 114.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example of a method the may be used to control communications between two devices, where the control may be performed by a third device. The third device may be a communication management server that may operate in conjunction with an application server. After establishing initial communications using the application server, the pairs of devices that may communicate perform a discovery operation, and the communication management server may perform an analysis to determine the best communication path.

Embodiment 200 illustrates an embodiment where a remote server may perform much of the analysis and control of the communications path, while the devices performing the communication may act as slaves or clients. Other embodiments, such as embodiment 300 illustrated later in this specification, may have some or all of the functions performed by the devices themselves.

The application server may establish communications with various devices in block 202. In some cases, the various devices may individually authenticate and establish a communication session with the server. Some such embodiments may use various encryption mechanisms, such as Secure Sockets Layer (SSL) or other security measures to secure the communication channel.

One example of an application server may be a server that administrates a synchronization system between several devices. In one architecture for such a system, the central server may perform authentication, then may facilitate connections between the various devices being synchronized. The synchronized data may be passed between the devices on the connections without having to pass through the server. Other embodiments may have different architectures that may pass data through the server, for example.

In block 204, the server may identify pairs of devices to communicate with each other. The pairs of devices may be those devices that have a communication path established between the two devices. In many embodiments, the application server may facilitate the connections by transmitting identifiers, addresses, and other credentials to the devices so that the devices may authenticate and secure a communication path.

In block 206, each device pair may be processed. For each pair, an initial communication session may be established. Then, a discovery process may be performed and the best communication path may be determined. The communication path may be changed to the best communication path and the communications monitored.

In block 208, the communicating peer devices may each determine their network address. The network address may include an IP address and port number when a device is behind a firewall, NAT, gateway, or other device. In order to find a network address for a device behind a NAT, the device may perform a query to a STUN server. In order to find a network address for a device behind a firewall, the device may perform a query to a TURN server. In other cases, the network address may be determined by other mechanisms.

The peer addresses may be exchanged in block 210 by the server, so that the peer to peer communication session may be established in block 212.

Once the initial communication path is established in block 212, the devices may communicate with each other.

The server may initiate a discovery operation in block 214 where the devices may gather metadata on alternative communication paths. In many cases, the metadata may include identifiers for devices and networks available on various communication mechanisms other than the initial communication path. In some cases, additional metadata may also be gathered. The metadata may also include metadata for the initial communication path established in block 212.

Additional metadata may include performance data for a communication path. For example, an Ethernet connection may have a maximum connection speed, while a wireless connection may have an available bandwidth. In some embodiments, a device may be able to measure available bandwidth either by performing an active test or by monitoring activity on the communication path. Other parameters such as latency, jitter, or other performance related parameters may also be gathered.

In some cases, a classification for the burstiness of a communication path may be included in the metadata. In this context, burstiness may be a measure of how well a communication path may handle bursty traffic, which may come in groups of communications that are transmitted sporadically. Bursty traffic is an antithesis of streaming traffic, where streaming traffic is continual and at a relatively constant level of traffic. Bursty traffic may perform better on connections with low jitter and low latency, while streaming traffic may perform better on connections with a constant bandwidth, but may tolerate higher jitter and latency. In many cases, streaming traffic may use a buffer to compensate for jitter and latency.

In some embodiments, the metadata may include other parameters such as cost variables for the communication path. Some connections, such as connections over a cellular telephony network or through a broadband Internet provider, may have costs associated with the bandwidth consumed or the number of minutes connected.

In some embodiments, a power consumption factor may be included in the metadata. Some connections may consume more power than other connections for a specific device. In some cases, the power consumption for transmitting across a connection may be orders of magnitude between different connections. Power consumption may be considered in cases where one or more devices may operate on battery power, for example.

After gathering the metadata regarding the communication paths, the metadata may be analyzed in block 216 to determine a best path. In cases where a server manages the communication paths, the analysis of block 216 may be performed by the server. In other cases, the analysis of block 216 may be performed by one or both of the devices that are communicating.

The analysis in block 216 may first evaluate the identifiers collected on alternate communication paths by each device to determine if any matches exist. After determining if the matches exist, the analysis may compare the existing communication path to any alternatives. If a better communication path exists in block 218, the communications may be redirected to the best path in block 220.

The best communication path may be determined by analyzing many different factors included in the metadata, including performance and cost of operating the connection, as well as the characteristics of the data being communicated.

In block 222, the communication path may be monitored for changes. If a change is to be made in block 224, the process may return to block 208 to perform another discovery operation and analysis.

The monitoring of block 224 may monitor both the communication stream as well as the communication path. If the communication stream changes characteristics, such as changing from a low bandwidth bursty transmission to a high bandwidth streaming transmission, a more appropriate communication path may be found by returning to block 208. If the communication path deteriorates, another communication path may be found by returning to block 208.

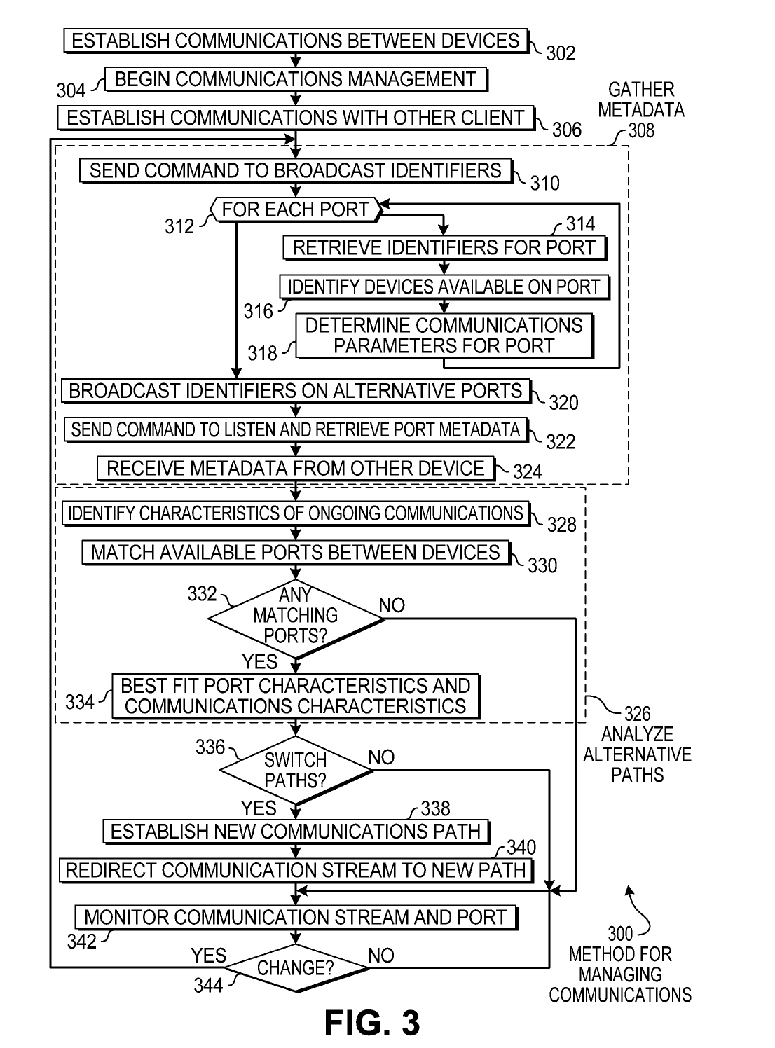

FIG. 3 is a flowchart illustration of an embodiment 300 showing a method for managing communications as may be performed by peers in communication with each other. Embodiment 300 is a simplified example of merely one method by which communications may be managed, and may contain some more detail than embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a method that may be performed by devices in communication with each other. After communication is established, a discovery operation may gather metadata about alternative communication paths, then the alternative paths may be analyzed. One of the paths may be selected and communications may be redirected along the new path. Embodiment 300 illustrates the operations that may be performed by one device acting as a communications manager within a peer to peer communication relationship.

Communications may be established between devices in block 302. In some cases, such as embodiment 200, the communications may be established with the assistance of a server. In other cases, the devices may establish a communication channel without such a server. In some embodiments, the communication path established in block 302 may be a secure communications path.

After communications are established in block 302, the communications management may begin in block 304.

In some embodiments, the communications management in block 304 may begin by launching and communicating with a management application on each device. An example of an architecture for such a system is illustrated in embodiment 400, found later in this specification.

The communications management begun in block 304 may start with establishing communications with a management client operating on the other device. The functions of the management client may be performed on a first device operating as the communications manager as well as the second device with which the first device communicates.

Some embodiments may perform the operations of the communications manager and communications client as background operations. The background operations may perform in parallel with the normal operations of the devices, which may include the transmission and reception and processing of data across the first communications path.

After establishing communications with the management client, metadata may be gathered in block 308. The operations illustrated within block 308 may be one embodiment of the operations that may be performed in block 214 of embodiment 200. Other embodiments may perform similar operations, or may perform a subset or superset of operations described in block 308.

Within block 308, a command may be sent to broadcast identifiers. The command by cause the management client to transmit an identifier on any available communication path. In some embodiments, the communications manager may define the identifier for the communications client to broadcast. In such embodiments, the identifier may be an address of the device on which the communications manager may operate. In other such embodiments, the identifier may be a GUID created by the communications manager, while other embodiments may use still other identifiers.

While the management client is broadcasting the identifier, each port may be analyzed in block 312. The analysis of each port may include retrieving any identifiers on the port in block 314 and identifying any devices on the port in block 316. The analysis may also include determining communications parameters for the port in block 318.

The communications parameters in block 318 may include performance parameters, such as bandwidth, jitter, latency, signal to noise ratio, or any other performance parameters. The communication parameters may also include configuration parameters that may be used to establish communications using the port. Such parameters may include addresses, channel numbers, communication speed, or other such parameters.

After analyzing each port in block 312, the communication manager may broadcast identifiers on each port in block 320, and send a command to the management client to listen and retrieve metadata in block 322. The command in block 322 may trigger the management client to perform the same steps as blocks 312-318.

After the management client performs the command transmitted in block 322, the metadata collected by the management client may be received in block 324.

After receiving the metadata, the analysis of alternative paths may be performed in block 326. The operations illustrated in block 326 are an example of the operations that may be performed in block 216 of embodiment 200. Other embodiments may perform similar or different operations, and some embodiments may have a subset or superset of operations than those illustrated in block 326.

The analysis of block 326 may start with identifying characteristics of ongoing communications in block 328. In many cases, the characteristics may include bandwidth and a characterization of burstiness of the communications.

The characteristics of block 328 may be determined by several different manners. In some embodiments, the data stream may be analyzed in some manner. For example, the quantity and consistency of the data may be tracked to determine the bandwidth consumed and burstiness. In other embodiments, the data stream may be characterized by metadata for the data stream. For example, a data stream may have metadata that describes bandwidth and burstiness, maximum latency, or other characteristics.

In block 330, available ports on the two devices may be matched. A match may be any communication path on both devices that have received the same identifiers, or through which the other device has been sensed. If no matching ports are identified in block 332, the process may jump to a monitoring operation in block 342.

If at least one matching port is identified in block 332, the best fit of port characteristics and communications characteristics may be performed in block 334 to determine a best communication path.

The best communication path may be the communication path that best meets the communication characteristics of the communication stream and the communication paths. In some cases, several different communication paths may fully meet the communication stream characteristics, but one communication path may be less expensive from a financial or power consumption standpoint, for example.

After determining the best communication path in block 334, and the best communication path is not the current communication path, a decision to switch paths may be made in block 336. If the best communication path is the current communication path, the paths may not be switched in block 336 and the process may jump forward to a monitoring operation in block 342.

If a communication path is to be switched in block 336, the new communication path may be established in block 338 and communications may be redirected to the new communications path in block 340.

In many cases, the establishment of a new communications path in block 338 may be performed by transmitting various identifiers between the devices using the initial communication path. The identifiers may include GUIDs or other unique identifiers that may be used to authenticate one device to another, as well as communication parameters that may be used to establish the new communications path. In cases where the new communication path may be encrypted, various encryption keys or other encryption related information may be transmitted and used in creating and maintaining the new communication path.

After the communication path is established in block 340, the monitoring operation of block 342 may begin. The monitoring operation of block 342 may monitor the data stream to detect if the characteristics of the data stream have changed. The monitoring operation may also monitor the performance and operation of the communication path to determine if the communication path is operating as expected.

In some embodiments, the monitoring operation of block 342 may monitor other communication paths to determine if those communication paths are now available for analysis.

If the monitoring operation of block 342 indicates that a change may be evaluated in block 344, the process may return to block 308 to gather metadata again and perform another analysis in block 326.

The embodiments 200 and 300 illustrate simplified embodiments where two devices are communicating with each other. Some embodiments may perform a similar operation with three, four, or more devices, where the devices may communicate amongst themselves using alternative communication paths.

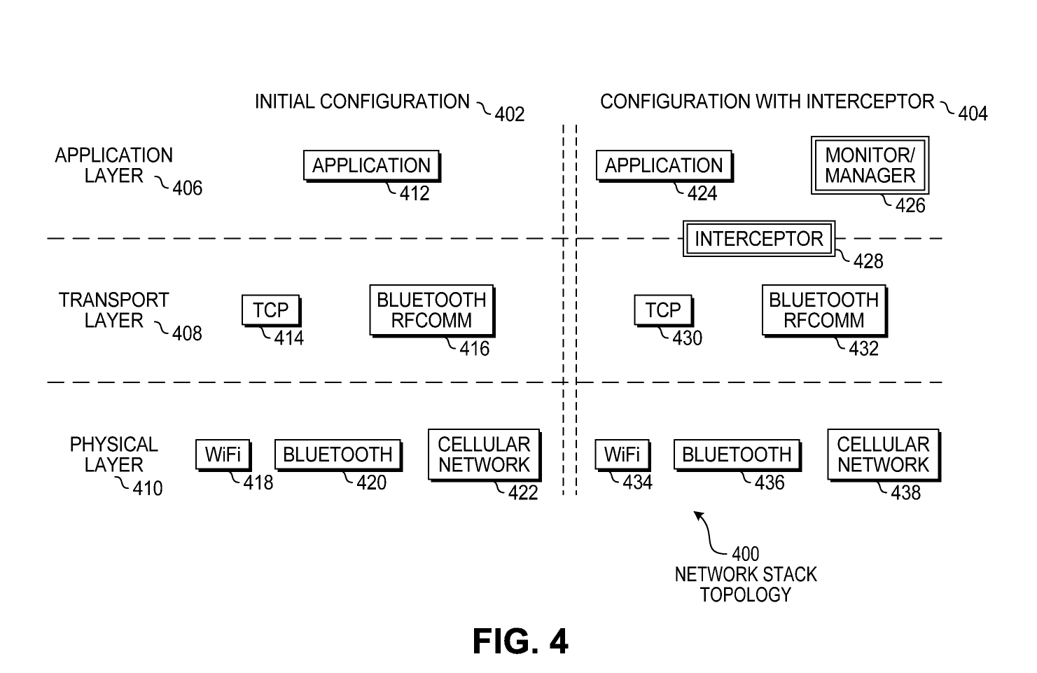

FIG. 4 is a diagram illustration of an embodiment 400 showing a network stack topology that may be used for a management client and for intercepting or redirecting a communication path. Embodiment 400 is a simplified example of merely one architecture for implementing the functionality described elsewhere in this specification.

Embodiment 400 illustrates a before and after view of a network stack to show the implementation of a management client and interceptor within the network stack. An initial configuration 402 is illustrated along with a modified configuration 404 that shows an interceptor and a management client.

The network stacks are illustrated with an application layer 406, a transport layer 408, and a physical layer 410. The layers illustrated may correspond with the OSI communication model and the TCP/IP communication model.

The application layer 406 may interface directly to and perform common application services for application processes. In the initial configuration 402, an application 412 is illustrated.

The transport layer 408 may encapsulate application data blocks into datagrams or packets suitable for transfer to a network infrastructure for transmission to a destination host, as well as managing the reverse transaction by abstracting network datagrams and delivering the data to an application. In the initial configuration 402, TCP 414 and Bluetooth RFCOMM 416 are illustrated as available transport layer components.

The physical layer 410 may define the mechanism for transmitting raw bits rather than logical datagrams over physical links connecting communicating devices. The physical layer may provide an electrical, mechanical, and procedural interface to a transmission medium. In the initial configuration 402, WiFi 418, Bluetooth 420, and Cellular Network 422 are illustrated as physical layer connections that may be used.

In the modified configuration 404, the application 424 is still present, along with the TCP 420 and Bluetooth RFCOMM 432 at the transport layer. The physical layer 410 still contains WiFi 434, Bluetooth 436, and Cellular Network 438.

The modified configuration 404 includes an interceptor 428 that resides between the application layer 406 and transport layer 408. The interceptor may intercept and modify inbound and outbound traffic, and may perform analysis of the traffic as well as redirect the traffic. Because the interceptor 428 resides below the application layer 406, the interceptor 428 may be used to redirect the communication stream to and from the application 424 without changing the application 424.

For example, the application 424 may be configured to transmit data over the TCP 430 on the transport layer, which may transmit data across a WiFi 434 connection on the physical layer. The interceptor 428 may be able to redirect the communication from the application 424 over the Bluetooth RFCOMM 432 connection on the transport layer and the Bluetooth 436 connection on the physical layer.

The interceptor 428 may be the mechanism by which a device's communication paths may be changed.

A manager client 426 may be an application that operates on the application layer 406. The manager client 426 may communicate with a communication manager, such as the communication managers 114 and 136 illustrated in embodiment 100. The manager client 426 may correspond to the communications client 138 in embodiment 100. The manager client 426 may be capable of exercising the various communication paths to gather metadata and monitor both the communication stream and the communication paths, as described in other embodiments.

When communication management is started, such as in block 304 of embodiment 300, the devices being managed may have an interceptor 428 and a management client 426 installed in the network stack. The management client 426 may receive commands, gather metadata, and transmit responses to a communications manager, and the interceptor 428 may redirect established communication sessions across different communication paths.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
establishing a first communication path between a first device and a second device, said first device and said second device comprising at least one alternative communication path, said first communication path being used for a first communication stream;
receiving metadata from said second device, said metadata comprising identifiers for available communication mechanisms;
analyzing said metadata to select a second communication path;
causing said first device and said second device to establish communications across said second communication path; and
redirecting said first communication stream from said first communication path to said second communication path using a redirection mechanism between an application layer and a transport layer in a network stack for said first device.

2. The method of claim 1 further comprising:
causing said first device to broadcast a signal on at least one alternative communication path, said signal comprising one of said identifiers.

3. The method of claim 1, said identifiers comprising an identifier for a third device connected to said alternative path.

4. The method of claim 3, said third device being a base station.

5. The method of claim 1 further comprising:
redirecting a second communication stream from a third communication path to said second communication path.

6. The method of claim 1, said metadata comprising at least one performance parameter for said alternative communication path.

7. The method of claim 6, said second communication path being determined by comparing a performance parameter for said first communication stream with a performance parameter for said second communication path.

8. The method of claim 7, said performance parameter comprising a descriptor describing burstiness.

9. The method of claim 1, said second communication path being established using an authentication mechanism.

10. The method of claim 9 further comprising:
causing a first unique identifier to be transmitted from said first device to said second device, said unique identifier being used by said authentication mechanism, said unique identifier being transmitted over said first communication path.

11. The method of claim 1, said metadata comprising a relative location.

12. The method of claim 1, said second communication path being established using an encryption mechanism.

13. The method of claim 12 further comprising:
causing an encryption key to be transmitted from said first device to said second device.

14. The method of claim 1, said second communication path comprising an ad-hoc network.

15. The method of claim 1, said method being performed by said first device.

16. The method of claim 1, said method being performed by a third device.

17. A communication manager operable on a first device, said communication manager being configured to perform a method comprising:
monitoring a first communication stream between said first device and a second device, said first communication stream being communicated on a first communication path;
receiving remote metadata from said second device, said metadata comprising identifiers for available communication mechanisms;
scanning at least one communication mechanism to determine local metadata, said communication mechanism being a communication mechanism not being used by said first communication path;
analyzing said local metadata and said remote metadata to select a second communication path;
establishing communications across said second communication path; and
redirecting said first communication stream from said first communication path to said second communication path by inserting a redirection mechanism between an application layer and a transport layer in a network stack for said first device.

18. The communication manager of claim 17, said first device having a firewall operable on said first communication path.

19. A communication server configured to perform a method comprising:
receiving first metadata from a first device, said first device communicating a first communication stream to a second device along a first communication path, said first metadata comprising identifiers identifying at least one alternative communication path available on said first device;
receiving second metadata from said second device, said second metadata comprising identifiers identifying at least one alternative communication path available on said second device;
analyzing said first metadata and said second metadata to select a second communication path;
causing said first device and said second device to establish communications across said second communication path by inserting a redirection mechanism between an application layer and a transport layer in a network stack for said first device and said second device; and
causing said first communication stream to be communicated at least in part using said second communication path.

20. The communication server of claim 19 further configured to:
establish said first communication path between said first device and said second device.
